(19) United States
(12) Patent Application Publication
(10) Pub. No.: US 2005/0225077 A1
(43) Pub. Date: Oct. 13, 2005

(54) Security document comprising an oscillating circuit

(75) Inventor: Martin Eichenberger, Zollikon (CH)

Correspondence Address: LADAS & PARRY, 26 WEST 61ST STREET, NEW YORK, NY, 10023, US

(73) Assignee: Orell Fussli Sicherherheitsdruck AG, Zurich (CH)

(21) Appl. No.: 10/514,362

(22) PCT Filed: Mar. 24, 2003
(86) PCT No.: PCT/IB03/01214

§ 371 Date: Apr. 25, 2005

(30) Foreign Application Priority Data
May 13, 2002 (EP) 02010143.2

(51) Int. Cl. B42D 15/00

(52) U.S. Cl. 283/72

(57) ABSTRACT

A banknote or another security document comprises a carrier (1), on which, inter alia, an electric resonant circuit (5) is arranged, which allows a verification of the security document. It can also be used to store information. Preferably, it is manufactured by means of printing techniques.

### CROSS REFERENCE TO RELATED APPLICATIONS

This application claims the priority of European patent application 02010143.2, filed May 13, 2002, the disclosure of which is incorporated herein by reference in its entirety.

### BACKGROUND OF THE INVENTION

The invention relates to a security document, such as a banknote, as well as to a method for encoding information on such a security document and a method for manufacturing it.

### STATE OF THE ART

Security documents, such as banknotes, cheques, papers of value, passports, identity cards, credit cards or bank cards, are, as a rule, provided with features that make counterfeiting them difficult. Security print features, micro perforations, holograms or inlaid metal threads have e.g. been known.

The problem to be solved by the present invention is to provide a further security feature for a security document of the type mentioned above.

### SUMMARY OF THE INVENTION

This problem is solved by the object of the independent claims.

Hence, according to the invention, the security document is provided with a resonant electric circuit that can be excited to a resonant oscillation by means of an applied electromagnetic ac field if the field frequency corresponds substantially to the resonance frequency of the resonant circuit. This allows to detect the resonant circuit in contact-less manner.

Preferably, the resonant circuit consists at least in part of an electrically conducting, printable material, which allows a production by means of printing techniques.

In a first preferred embodiment, the security document is a banknote.

In another preferred embodiment the security document comprises several sheets bounds in a binder, such as it is e.g. customary for passports. If the resonant circuit is arranged in or on the binder, it is mechanically protected in a better manner, in particular if the binder is of a less pliable material than the sheets.

A particularly robust arrangement results if the capacitor electrodes of the resonant circuit are arranged on opposite sides of the carrier of the security document.

Several different resonant circuits of differing resonant frequency can be provided as well, which increases security against counterfeiting. In this case, the difference frequency between the resonant frequencies of the resonant circuits can be measured as well.

It is also possible to provide a whole set of banknotes with resonant circuits. In this case, the resonance frequency and/or the arrangement of the resonant circuit can be chosen in dependence of the denomination of the corresponding banknote. The security document can, however, also be designed e.g. as a passport or identity card.

As it has already been mentioned for banknotes, it is also possible to encode an information in the security document by means of the selected resonance frequency or the arrangement of the resonant circuit. Preferably, the resonance frequency is selected in dependence of a further information, wherein the further information is arranged in suitable form (e.g. encoded or in plain text) on the security document. In this case, a authenticity check can be carried out by comparing the information.

### BRIEF DESCRIPTION OF THE DRAWINGS

Further embodiments, advantages and applications of the invention are disclosed in the dependent claims and the now following description by reference to the figures, which show

FIG. 1 a banknote with two resonant circuits,

FIG. 2 a sectional view along line II-II of FIG. 1,

FIG. 3 a passport with a resonant circuit,

FIG. 4 a further embodiment and

FIG. 5 a sectional view along line V-V of FIG. 4.

### WAYS FOR CARRYING OUT THE INVENTION

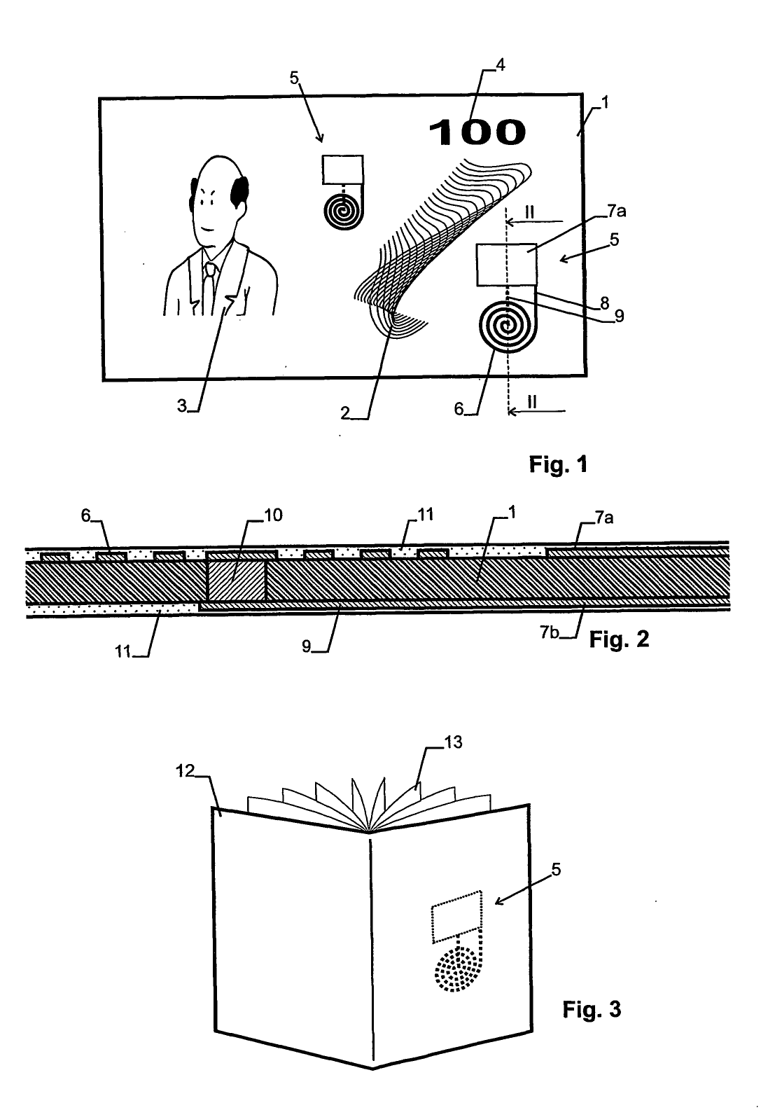

The banknote of FIG. 1 comprises a carrier 1 of paper or flexible plastics, which is printed on from both sides. In the present embodiment, conventional graphical elements 2, 3 and a denomination 4 have been printed on the banknote. In addition, two resonant circuits 5 are arranged on the bank note.

The design of the resonant circuits 5 can be seen from FIGS. 1 and 2. Each resonant circuit comprises an inductance L consisting of a spiral shaped coil 6 and a capacitor C with two electrodes 7a, 7b on opposite sides of the electrically insulating carrier 1. Inductance L and capacitor C are closed to a current circuit by means of connecting lines 8, 9. Connecting line 8 is located on the same side of carrier 1 as coil 6 and electrode 7a. Connecting line 9 is arranged, together with electrode 7b, on the opposite side of the carrier 1. As a connection between coil 6 and connecting line 9, at least one through contact 10 is provided, which extends through carrier 1. As can be seen from FIG. 2, coil 6, the electrodes 7a, 7b and the connecting lines 8, 9 can be protected by means of protective layers 11, e.g. made of a transparent or non-transparent plastic.

The inductance L and the capacitor C together form a resonant circuit with the resonance frequency.

$$f = \frac{1}{2 π \sqrt{L \cdot C}}$$

If the banknote is brought into an electromagnetic ac field with frequency f, the resonant circuit is excited to an oscillation in resonance, which can be detected. Corresponding detection circuits have been known from anti-theft systems and do not have to be described here in detail.

As can be seen from FIG. 1, two resonant circuits 5 of different size and therefore different resonance frequency are arranged on the shown embodiment. This allows to increase the counterfeiting safety of the document. It is also possible to arrange several resonant circuits 5 of equal frequency on the document. This increases reliability because a resonance can still be detected even if one resonant circuit is damaged.

Preferably, notes of different value are equipped with resonant circuits having different resonance frequency. This allows a determination of the note denomination by means of the resonance frequency and increases the counterfeiting safety. It is also possible to distinguish notes of different countries of origin because of the resonance frequency of their resonant circuit or circuits. Hence, by choosing the resonance frequency of the resonant circuit or circuits, an information can be encoded. This can (as in the embodiment of the note denomination) be an information that stands in relation to a further information printed onto the security document or arranged in another manner thereon. This allows a verification of the authenticity of the document by comparison of the information. Instead of or in addition to encoding of information by means of the resonance frequency, information can also be stored by means of the location of the resonant circuits on the document.

In the embodiment of FIG. 1, the resonant circuits 5 are visible from the outside and can be taken into account in a visual check of authenticity. They can also be used as design elements.

The resonant circuits 5 can, however, also be covered by a non-transparent layer 11 and therefore be invisible. They can also be arranged within the carrier 1 instead of on one of its surfaces.

FIGS. 1 and 2 show only one possible design of the resonant circuits. From the field of anti-theft devices, a plurality of geometries for laminated electric resonant circuits have been known, which can be used for the present purpose.

The resonant circuits 5 can be manufactured by applying electrically conducting ink, e.g. of a material that can be applied by printing techniques, such as screen printing. For manufacturing the through contacts 10, one or more holes can be manufactured in the substrate 1, e.g. by means of laser beams, prior to applying the electrically conducting ink. These can then be filled with electrically conducting ink or another electrical conductor.

It is, however, also possible to manufacture the resonant circuits or parts thereof by applying conducting structures in different manner, e.g. in the shape of coatings or foils, on the carrier 1 or into the carrier 1. Further, it is possible to prefabricate the resonant circuit separately from the banknote and then to attach to the same.

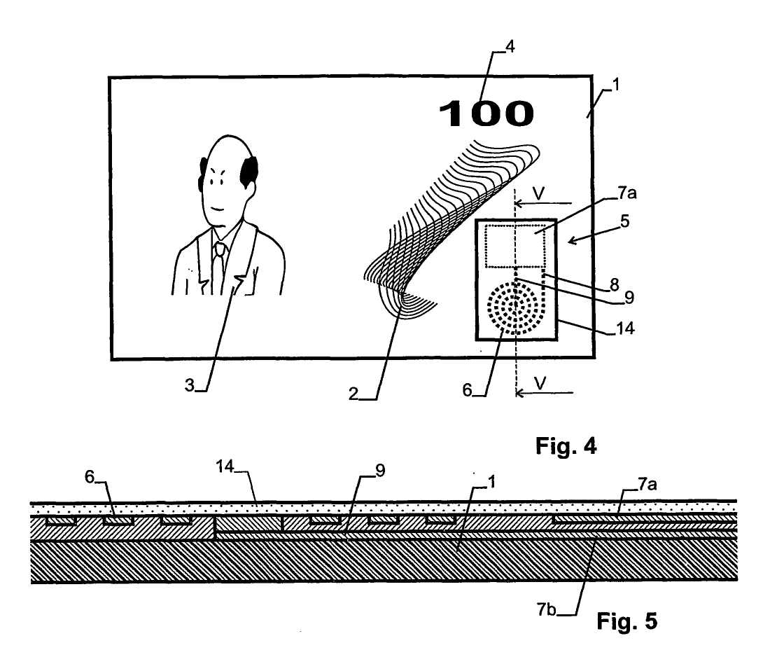

An example of this type is shown in FIGS. 4 and 5. Here, a resonant circuit has been arranged on the backside of an “optically variable device” (OVD) 14, which carries a hologram or kinegram on its front side (not shown), the subject of which changes depending on the viewing angle. By arranging the resonant circuit on the backside of a substrate, the front side of which comprises an optically visible security mark, and then applying the substrate to the security document, two security features (OVD and resonant circuit) can be applied to the document in a single step.

Marking by means of resonant circuits is suited for all security documents, such as documents of value, deeds, or passports. In addition, it is also suited for application on plastic cards, such as identity cards or credit cards.

FIG. 3 shows a passport with a non-pliable binder 12 and several sheets 13 bound in binder 12. As schematically shown, the resonant circuit is, in this case, preferably arranged in binder 12 because there it is best protected from damage. Also in this case, several resonant circuits can be provided and/or the resonance frequency of the resonant circuit can e.g. depend on the country of origin, the passport number and/or to individual data of the passport owner.

It is also possible to apply a resonant circuit on the “personalization page” of the passport, i.e. on the page that contains the individualized data of its owner.

While in the present application there are described preferred embodiments of the invention, it is to be distinctly understood that the invention is not limited to the same and can also be carried out in different manner within the scope of the following claims.

1. A security document comprising a resonant electric circuit that can be excited by means of an applied electromagnetic field.

2. The security document of claim 1, wherein the resonant circuit comprises a capacitor comprising at least two electrodes formed by conducting layers, wherein the electrodes are separated by a non-conducting layer.

3. The security document of claim 1, wherein the security document comprises a carrier of paper or plastics that has been printed on.

4. The security document of claim 2, further comprising a carrier of paper or plastics that has been printed on, wherein the electrodes (7a, 7b) are arranged on opposite sides of the carrier (1).

5. The security document of claim 1, wherein the resonant circuit comprises electrically conducting, printable material.

6. The security document of claim 1, wherein at least a part of the resonant circuit is visible from outside.

7. The security document of claim 1, wherein the security document comprises several sheets bound in a binder, wherein the resonant circuit is arranged in or on the binder.

8. The security document of claim 1, comprising several resonant circuits with different resonance frequency.

9. The security document of claim 1, wherein the resonant circuit comprises a through contact extending through the security document.

10. The security document of claim 1, wherein the resonant circuit comprises a spiral shaped coil.

11. The security document of claim 1 that is designed as a banknote.

12. The security document of claim 1 that is designed as a passport or identity card.

13. The security document of claim 1 wherein the resonant circuit is arranged at the backside of a substrate, wherein an optical security mark is arranged at the front side of the substrate, and wherein the substrate is arranged on the security document.

14. A set of banknotes of security documents of claim 1 with different denominations, wherein resonant circuits with different resonant frequencies are attributed to different denominations.

15. A method for encoding information in a security document of claim 1, wherein the information to be encoded defines the resonance frequency or resonance frequencies and/or the arrangement of the resonant circuit or resonant circuits.

16. The method of claim 15, wherein the information encoded in the resonance frequency or arrangement is in relation to a further information encoded on the security document such that the information encoded in the resonance frequency and the further information can be compared to each other for verifying the security document.

17. A method for manufacturing a security document comprising the step of adding a resonant electric circuit to said security document using printing techniques.

18. The method of claim 17, wherein the resonant circuit comprises a through contact extending through the document, wherein the through contact is manufactured by generating an opening in the security document by means of a laser beam and by introducing a conductor into the opening.

19. A security document comprising
a carrier of paper or plastics that is printed on,
a resonant electric circuit excitable by an applied electromagnetic field,
a capacitor as part of the resonant circuit (5), wherein the capacitor comprises at least two electrodes formed by conducting layers, wherein the electrodes are arranged at opposite sides of the carrier.

20. Security document of claim 19, wherein the resonant circuit comprises a through contact extending through the carrier.

21. The security document of claim 7, wherein the binder is of a less pliant material than the sheets.

22. A set of banknotes wherein each banknote comprises
a carrier having a denomination inscribed thereon,
at least one resonant electric circuit arranged on said carrier, wherein said resonant electric circuit is excitable at a resonance frequency,
wherein the resonant electric circuits of banknotes of differing denominations have different resonance frequencies.
